(19) United States
(12) Patent Application Publication
(10) Pub. No.: US 2006/0161695 A1
(43) Pub. Date: Jul. 20, 2006

(54) Direct memory access system

(75) Inventors: Shuji Mochizuki, Kawasaki-shi (JP); Kazushi Hayashi, Sagamihara-shi (JP)

Correspondence Address: PANASONIC PATENT CENTER;c/o MCDERMOTT WILL & EMERY LLP, 600 13TH STREET, NW, WASHINGTON, DC, 20005-3096, US

(73) Assignee: MATSUSHITA ELECTRIC INDUSTRIAL CO., LTD.

(21) Appl. No.: 11/303,022

(22) Filed: Dec. 16, 2005

(30) Foreign Application Priority Data
Dec. 17, 2004 (JP) P2004-365727

(51) Int. Cl. G06F 13/28

(52) U.S. Cl. 710/22

(57) ABSTRACT

A direct memory access system has a DMA setting decoding portion 17 and a DMA clock/reset control portion 18. The DMA setting decoding portion 17 acquires various pieces of DMA data transfer control information including a data transfer length and a data transfer target from information set in a DMA controller 2, and determines not-operative circuit portions uninvolved in the DMA data transfer based on the DMA data transfer control information. The DMA clock/reset control portion 18 controls suspension of clock supply to the not-operative circuit portions at the timing of start of the DMA data transfer and resumption of the clock supply at the timing of termination of the DMA data transfer. The DMA setting decoding portion 17 detects the start of the DMA data transfer and calculates the timing of resumption of clock supply during suspension of the clock supply based on the DMA data transfer control information. Thus, the clock supply timing is controlled.

### BACKGROUND OF THE INVENTION

1. Field of the Invention

The present invention relates to a direct memory access system for performing data transfer using direct memory access (DMA), and particularly relates to a technique for reducing system power consumption during DMA data transfer.

2. Description of the related art

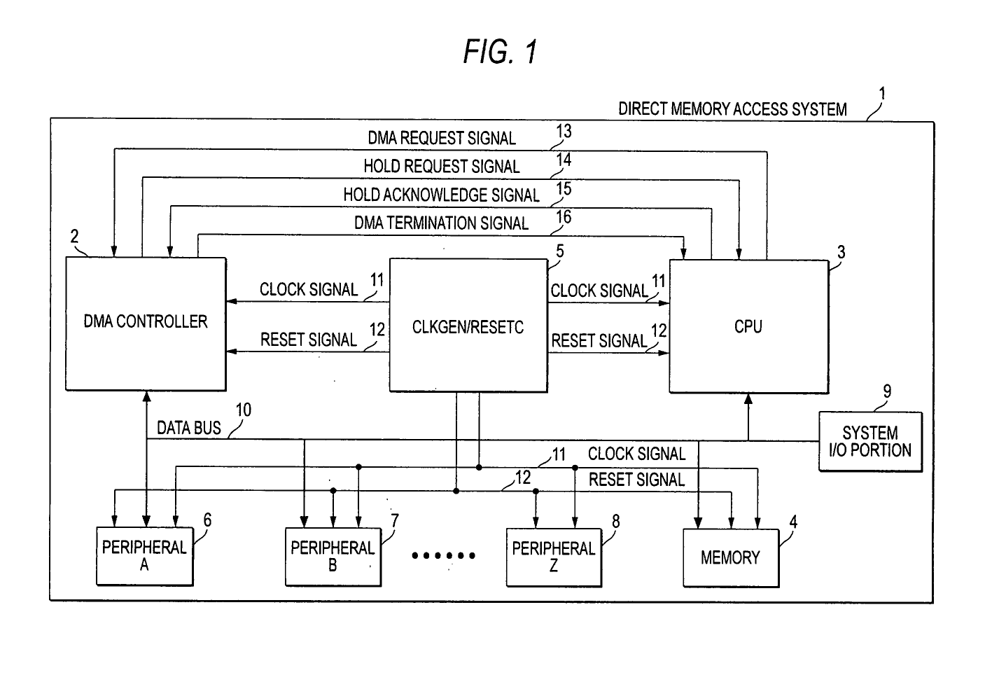

In a configuration of a direct memory access system in the background art, a clock is supplied to circuits uninvolved in data transfer during DMA data transfer. Thus, power unnecessary for the system is consumed. FIG. 1 is a block diagram showing an example of a configuration of a background-art direct memory access system. The fundamental operation of DMA processing will be described with reference to FIG. 1.

In a direct memory access system 1 shown in FIG. 1, a CPU 3, a DMA controller 2, a memory 4, a clock generation/reset control portion (CLKGEN/RESETC) 5, a system I/O portion 9 and a plurality of peripherals including a peripheral 6, a peripheral 7 and a peripheral 8 are connected to one another through a data bus 10, a clock signal 11 and a reset signal 12.

Supplying the clock signal 11 and the reset signal 12 to each block is totally controlled by the CLKGEN/RESETC 5. Here, assume that DMA data transfer is executed between the peripheral 6 and the memory while no data transfer is executed among the other peripherals 7 and 8 and the system I/O portion 9. In this case, DMA processing is carried out along the following procedure.

First, the CPU 3 sets control information necessary for DMA data transfer in the DMA controller 2. In this event, since data transfer between the peripheral 6 and the memory 4 is required, the CPU 3 sends a DMA request signal 13 to the DMA controller 2 and transfers control information necessary for the DMA data transfer to the DMA controller 2 through the data bus 10.

Upon reception of the DMA request signal 13, the DMA controller 2 sends a hold request signal 14 to the CPU 3 for bus use permission. Upon reception of the hold request signal 14, the CPU 3 sends the DMA controller 2 a hold acknowledge signal 15 to permit the bus use, and releases the data bus 10. The DMA controller 2 uses the released bus to execute data transfer between the peripheral 6 and the memory 4 in place of the CPU 3.

When the DMA data transfer is terminated in the aforementioned procedure, the DMA controller 2 sends a DMA termination signal 16 to the CPU 3. Upon reception of the DMA termination signal 16, the CPU 3 resumes the released data bus 10 and proceeds with program processing.

In such a manner, the clock signal 11 from the CLKGEN/RESETC 5 is continuously supplied to the peripherals 7 and 8 and the system I/O portion 9 in spite of DMA data transfer between the peripheral 6 and the memory 4. Accordingly, there is a problem that unnecessary power is constantly consumed.

As a solution to this problem, there is a technique for reducing the system power consumption during DMA data transfer. That is, a clock is supplied only to required circuits before DMA data transfer. Thus, circuits to be activated are limited to suppress the total power consumption (for example, see Japanese Patent Laid-Open No. 100710/1991).

In the aforementioned configuration of the background-art direct memory access system, a clock signal is continuously supplied to blocks uninvolved in data transfer when DMA data transfer is performed between a memory and a peripheral or between the memory and a system I/O portion. Accordingly, there is a problem that unnecessary power is constantly consumed.

On the other hand, in the technique of Patent Document 1 where a clock is supplied only to required circuits before DMA data transfer, an additional cycle is required before and after the transfer. Thus, there is a problem that overhead increases in a system frequently performing DMA data transfer.

### SUMMARY OF THE INVENTION

An object of the invention is to provide a direct memory access system in which unnecessary power consumption in DMA data transfer is suppressed so that the system power consumption can be reduced.

A direct memory access system according to the invention includes: a DMA setting decoding portion built in a DMA controller for controlling DMA data transfer using direct memory access, the DMA setting decoding portion acquiring various pieces of DMA data transfer control information from information set in the DMA controller and determining not-operative circuit portions uninvolved in the DMA data transfer on the basis of the DMA data transfer control information, the DMA data transfer control information including a data transfer length and a data transfer target; and a DMA clock/reset control portion built in a clock generation portion for supplying a system clock, the DMA clock/reset control portion controlling suspension of clock supply to the not-operative circuit portions at the time of start of the DMA data transfer and resumption of the clock supply to the not-operative circuit portions at the time of termination of the DMA data transfer.

According to the invention, the DMA setting decoding portion includes: a command issuing timing detection portion for recognizing issuing timing of a DMA data transfer start command so as to detect start of the DMA data transfer at the time of occurrence of the DMA data transfer; a DMA parameter decoding portion for decoding the information set in the DMA controller so as to acquire the DMA data transfer control information; and a transfer target space setting portion for setting an address space of a DMA data transfer target.

According to the invention, the DMA clock/reset control portion determines validity of suspension of clock supply to the not-operative circuit portions on the basis of the DMA data transfer control information acquired from the DMA setting decoding portion, and controls to perform operations on the not-operative circuit portions when suspension of clock supply to the not-operative circuit portions is concluded to be valid, the operations including suspension of clock supply at the time of start of the DMA data transfer and resumption of the clock supply and issue of a reset signal immediately before termination of the DMA data transfer.

According to the aforementioned configuration, a data transfer target is specified in the DMA controller when DMA data transfer is performed. Thus, clock supply to circuit portions uninvolved in DMA data transfer can be suspended during the DMA data transfer so that the power consumption during the DMA data transfer can be reduced.

In addition, timing of start of the DMA data transfer and timing of termination thereof can be acquired accurately so that clock supply to the circuit portions uninvolved in the DMA data transfer can be suspended before the start of the DMA data transfer, and the clock supply can be resumed immediately before the termination of the DMA data transfer. Accordingly, the power consumption during the DMA data transfer can be reduced without generating any additional cycle before and after the transfer.

A direct memory access method according to the invention is a direct memory access method for performing DMA data transfer using direct memory access, including the steps of: acquiring various pieces of DMA data transfer control information from information set in a DMA controller for controlling the DMA data transfer, the DMA data transfer control information including a data transfer length and a data transfer target; determining not-operative circuit portions uninvolved in the DMA data transfer on the basis of the DMA data transfer control information; suspending clock supply to the not-operative circuit portions at the time of start of the DMA data transfer; and resuming the clock supply to the not-operative circuit portions immediately before termination of the DMA data transfer.

According to the invention, the direct memory access method further includes the steps of: recognizing issuing timing of a DMA data transfer start command so as to detect start of the DMA data transfer at the time of occurrence of the DMA data transfer; and calculating timing of suspension of clock supply to the not-operative circuit portions and timing of resumption of the clock supply to the not-operative circuit portions on the basis of the DMA data transfer control information.

According to the aforementioned configuration, a data transfer target is specified in the DMA controller when DMA data transfer is performed. Thus, clock supply to circuit portions uninvolved in DMA data transfer can be suspended during the DMA data transfer. Further, timing of suspension of clock supply to the circuit portions and timing of resumption of the clock supply to the circuit portions can be determined accurately. Accordingly, the power consumption during the DMA data transfer can be reduced without generating any additional cycle before and after the transfer.

According to the invention, suspension of clock supply to circuit portions uninvolved in DMA data transfer and resumption of the clock supply to the circuit portions can be controlled at proper timing during the DMA data transfer. It is therefore possible to reduce the power consumption without increasing overhead as to the processing time of DMA data transfer operation.

### BRIEF DESCRIPTION OF THE DRAWIGS

FIG. 1 is a block diagram showing an example of a configuration of a direct memory access system in the background art.

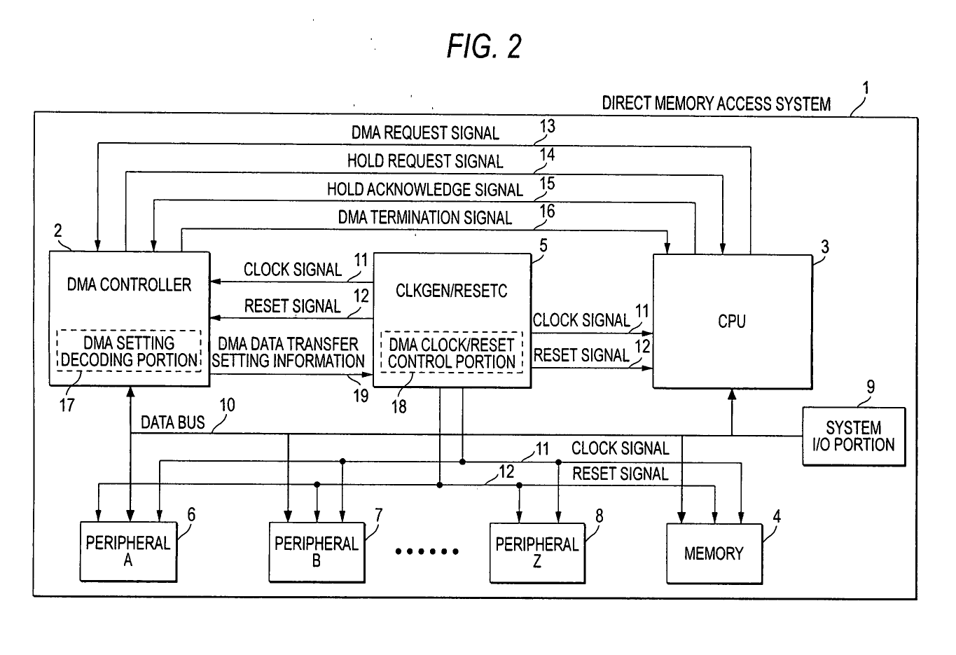

FIG. 2 is a block diagram showing an example of a configuration of a direct memory access system according to an embodiment of the invention.

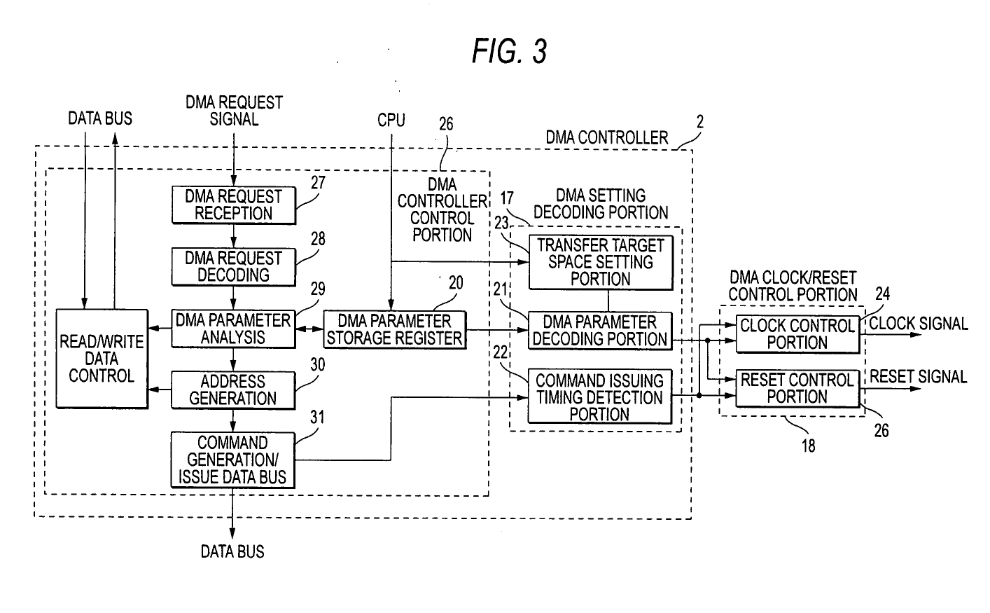

FIG. 3 is a block diagram showing a detailed configuration of each control portion in the direct memory access system according to the embodiment of the invention.

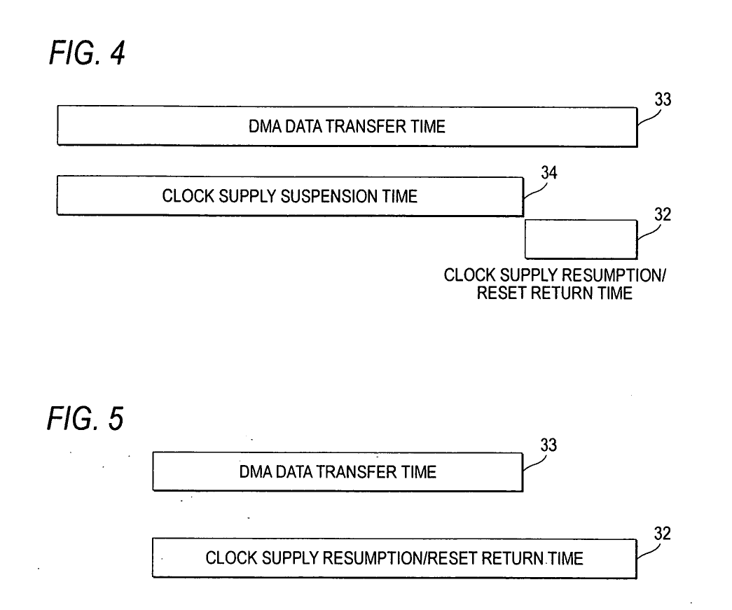

FIG. 4 is a diagram for explaining a case where a DMA data transfer time is longer than a clock supply resumption/reset return time.

FIG. 5 is a diagram for explaining a case where the DMA data transfer time is shorter than the clock supply resumption/reset return time.

### DESCRIPTION OF THE PREFERRED EMBODIMENTS

An embodiment of the invention will be described below with reference to the drawings. FIG. 2 is a block diagram showing the configuration of a direct memory access system according to an embodiment of the invention.

In the configuration of the direct memory access system in FIG. 2, a DMA setting decoding portion 17 built in the DMA controller 2 and a DMA clock/reset control portion 18 built in the CLKGEN/RESETC 5 are additionally provided, and DMA data transfer setting information 19 as an information transfer path from the DMA setting decoding portion 17 to the DMA clock/reset control portion 18 is added to the background-art direct memory access system shown in FIG. 1.

FIG. 3 is a block diagram showing the detailed configuration of the DMA setting decoding portion 17 and a DMA controller control portion 26 built in the DMA controller 2 and the detailed configuration of the DMA clock/reset control portion 18 built in the CLKGEN/RESETC 5.

The DMA controller control portion 26 has a read/write data control circuit for the data bus, a DMA parameter storage register 20 for receiving DMA data transfer control information from the CPU, and a series of processing functions including DMA request reception 27, DMA request decoding 28, DMA parameter analysis 29, address generation 30 and command generation/issue 31.

The DMA setting decoding portion 17 is constituted by a DMA parameter decoding portion 21, a command issuing timing detection portion 22 and a transfer target space setting portion 23. The DMA clock/reset control portion 18 is constituted by a clock control portion 24 and a reset control portion 25.

The DMA parameter decoding portion 21 acquires, from the DMA parameter storage register 20, various pieces of setting information required for clock/reset control during DMA data transfer. The command issuing timing detection portion 22 observes issuing of a DMA data transfer start command inside the DMA controller 2. The transfer target space setting portion 23 holds an address space of a DMA data transfer target set by the CPU 3.

The clock control portion 24 acquires a signal from the command issuing timing detection portion 22, determines whether to suspend clock supply or not from a reset/clock supply time proper to the system, suspends the clock supply based on the determination result, and resumes the clock supply based on the setting information of the DMA parameter decoding portion 21.

Based on the clock control portion 24 and the setting information of the DMA parameter decoding portion 21, the reset control portion 25 performs reset release upon the blocks for which the clock supply has been suspended.

To start DMA data transfer, the CPU 3 sets a start address and a transfer length in the DMA parameter storage register 20 as control information required for the DMA data transfer. The CPU also sets an address space region of a transfer target in the transfer target space setting portion 23 in advance.

From the start address set thus and the transfer target space information 23 set in advance, the DMA setting decoding portion 17 specifies blocks for which clock supply can be suspended because the blocks are out of the target of the DMA data transfer. From the transfer length, the DMA setting decoding portion 17 also acquires information about the time to resume the blocks for which the clock supply has been suspended.

In the DMA controller 2 receiving the DMA request signal 13 from the CPU 3, processing is performed in the procedure of the DMA request reception 27, the DMA request decoding 28, the DMA parameter analysis 29 and the address generation 30, and the command generation/issue 31 is executed over the data bus 10.

In the DMA setting decoding portion 17, the timing of the command generation/issue 31 is detected, and a request from the DMA parameter decoding portion 21 for suspension of clock supply to peripherals to which clock supply should be suspended is transferred to the clock control portion 24. Here, in the DMA clock/reset control portion 18, whether to suspend clock supply or not is determined from the reset/clock supply time set by hardware properly to the system.

In addition, the timing to perform reset release and resume clock supply is determined from the transfer length information, and transferred to the reset control portion 25 and the clock control portion 24. The clock signal 11 and the reset signal 12 are connected from the clock control portion 24 and the reset control portion 25 to each block respectively. After the suspension of clock supply to blocks unused during DMA data transfer, the reset release and the resumption of the clock supply, the blocks to which the clock supply has been suspended are resumed as soon as the DMA data transfer is completed.

In the resumption of clock supply, the clock is supplied again to the blocks to which the clock supply has been suspended before the termination of the DMA data transfer, on the basis of the timing of the resumption of clock supply and the reset return determined from the start address and the transfer length. Thus, all the circuits as DMA data transfer targets can return to active states at the time of termination of the DMA data transfer.

In addition, the total time from the suspension of clock supply to the resumption of the clock supply and the DMA data transfer time determined from the start address and the transfer length are compared with each other at the time of start of the DMA data transfer. When the DMA data transfer time is shorter, the clock supply is not suspended. FIG. 4 and FIG. 5 are diagrams for explaining the comparison between the DMA data transfer time and the clock supply resumption/reset return time.

FIG. 4 shows a case where a DMA data transfer time 33 is longer than a clock supply resumption/reset return time 32. In this case, there occurs a clock supply suspension time 34 to suspend clock supply. In the clock supply suspension time 34, clock supply is suspended during DMA data transfer by the DMA clock/reset control portion 18.

FIG. 5 shows a case where the DMA data transfer time 33 is shorter than the clock supply resumption/reset return time 32. In this case, if clock supply is suspended, the performance of the system operating as a whole will be lowered. Accordingly, the DMA clock/reset control portion 18 does not suspend clock supply.

The direct access system according to the invention can control suspension of clock supply to circuit portions uninvolved in DMA data transfer and resumption of the clock supply at proper timing during the DMA data transfer. Accordingly, there is an effect that the power consumption can be reduced without increasing overhead as to the processing time of DMA data transfer operation. Thus, the direct access system according to the invention is useful as a technique etc. for reducing the system power consumption during DMA data transfer.

What is claimed is:

1. A direct memory access system comprising:
a DMA setting decoding portion built in a DMA controller for controlling DMA data transfer using direct memory access (DMA), said DMA setting decoding portion acquiring various pieces of DMA data transfer control information from information set in said DMA controller and determining not-operative circuit portions uninvolved in said DMA data transfer on the basis of said DMA data transfer control information, said DMA data transfer control information including a data transfer length and a data transfer target; and
a DMA clock/reset control portion built in a clock generation portion for supplying a system clock, said DMA clock/reset control portion controlling suspension of clock supply to said not-operative circuit portions at the time of start of said DMA data transfer and resumption of said clock supply to said not-operative circuit portions at the time of termination of said DMA data transfer.

2. The direct memory access system according to claim 1, said DMA setting decoding portion including:
a command issuing timing detection portion for recognizing issuing timing of a DMA data transfer start command so as to detect start of said DMA data transfer at the time of occurrence of said DMA data transfer;
a DMA parameter decoding portion for decoding said information set in said DMA controller so as to acquire said DMA data transfer control information; and
a transfer target space setting portion for setting an address space of a DMA data transfer target.

3. The direct memory access system according to claim 1, wherein said DMA clock/reset control portion determines validity of suspension of clock supply to said not-operative circuit portions on the basis of said DMA data transfer control information acquired from said DMA setting decoding portion, and controls to perform operations on said not-operative circuit portions when suspension of clock supply to said not-operative circuit portions is concluded to be valid, said operations including suspension of clock supply at the time of start of said DMA data transfer and resumption of said clock supply and issue of a reset signal immediately before termination of said DMA data transfer.

4. A direct memory access method for performing DMA data transfer using direct memory access (DMA), comprising the steps of:
acquiring various pieces of DMA data transfer control information from information set in a DMA controller for controlling said DMA data transfer, said DMA data transfer control information including a data transfer length and a data transfer target;
determining not-operative circuit portions uninvolved in said DMA data transfer on the basis of said DMA data transfer control information;
suspending clock supply to said not-operative circuit portions at the time of start of said DMA data transfer; and
resuming said clock supply to said not-operative circuit portions immediately before termination of said DMA data transfer.

5. The direct memory access method according to claim 4, further comprising the steps of:
recognizing issuing timing of a DMA data transfer start command so as to detect start of said DMA data transfer at the time of occurrence of said DMA data transfer; and
calculating timing of suspension of clock supply to said not-operative circuit portions and timing of resumption of said clock supply to said not-operative circuit portions on the basis of said DMA data transfer control information.
